(19) United States
(12) Patent Application Publication
(10) Pub. No.: US 2013/0256233 A1
(43) Pub. Date: Oct. 3, 2013

(54) Device for Separating Ferromagnetic Particles From a Suspension

(71) Applicants: Vladimir Danov, Erlangen (DE); Werner Hartmann, Weisendorf (DE); Wolfgang Krieglstein, Nurnberg (DE); Andreas Schröter, Erlangen (DE)

(72) Inventors: Vladimir Danov, Erlangen (DE); Werner Hartmann, Weisendorf (DE); Wolfgang Krieglstein, Nurnberg (DE); Andreas Schröter, Erlangen (DE)

(21) Appl. No.: 13/989,857

(22) PCT Filed: Nov. 18, 2011
(86) PCT No.: PCT/EP11/70482

§ 371 Date: May 28, 2013

(30) Foreign Application Priority Data
Nov. 25, 2010 (DE) 10 2010 061 952.3

(51) Int. Cl. B03C 1/033

(52) U.S. Cl. CPC B03C 1/0335
USPC 210/695; 210/222

(57) ABSTRACT

A device for separating ferromagnetic particles from a suspension may include a tubular reactor through which the suspension can flow and which has an inlet and an outlet, and a means for generating a magnetic field along an inner reactor wall, and a displacement body arranged in the interior of the reactor. Means for generating a magnetic field are provided on the displacement body, on an outer wall of the displacement body.

### CROSS-REFERENCE TO RELATED APPLICATIONS

This application is a U.S. National Stage Application of International Application No. PCT/EP2011/070482 filed Nov. 18, 2011, which designates the United States of America, and claims priority to DE Patent Application No. 10 2010 061 952.3 filed Nov. 25, 2010. The contents of which are hereby incorporated by reference in their entirety.

### TECHNICAL FIELD

This disclosure relates to a device for separating ferromagnetic particles from a suspension.

### BACKGROUND

There are a large number of technical tasks which involve separating ferromagnetic particles from a suspension. One important area where this takes place is the separation of reusable ferromagnetic particles from a suspension containing ground ore. These are not just iron particles, which are to be separated from an ore; other reusable materials, for example particles containing copper, which are not ferromagnetic per se, can be chemically coupled with ferromagnetic particles, for example magnetite, and thus be separated selectively from the suspension containing the entire ore. Ore here refers to a raw rock material, which contains particles of reusable material, in particular metal compounds, which are reduced to metals in a further reduction process.

Magnetic separation methods serve to extract ferromagnetic particles selectively from the suspension and separate them. The magnetic separation system structure that has proved expedient comprises a tubular reactor, on which coils are arranged so that a magnetic field is generated on an inner reactor wall, where the ferromagnetic particles collect and are conveyed from there in an appropriate manner. Modern embodiments of such tubular reactors also comprise a so-called displacement body in their interior, which serves to adjust the width of a separating channel to the penetration depth of the magnetic field into the suspension, so that the volume through which the flow passes is penetrated to the greatest possible degree by the generated magnetic field and the ferromagnetic particles present in the suspension are picked up as effectively as possible by the magnetic field.

The use of a displacement body per se is a suitable means for improving the penetration of the suspension flowing through the reactor by the magnetic field, which already has a positive impact on the overall separation rate for ferromagnetic particles. However it is necessary, in order to improve the economic viability of the separation process and therefore of the overall ore extraction process, to increase the magnetic field penetration of the suspension flowing through the reactor further.

### SUMMARY

One embodiment provides a device for separating ferromagnetic particles from a suspension, having a tubular reactor through which the suspension can flow with an inlet and an outlet and means for generating a magnetic field along an inner reactor wall and a displacement body arranged in the interior of the reactor, wherein means for generating a magnetic field on an outer wall of the displacement body are provided on the displacement body.

In a further embodiment, the means for generating a magnetic field are configured to generate a migrating magnetic field.

In a further embodiment, a migrating field is present on the inner reactor wall and on the outer wall of the displacement body.

In a further embodiment, the migrating field migrates in the throughflow direction.

In a further embodiment, annular apertures are respectively arranged equidistant from the inner reactor wall and the outer wall of the displacement body at the outlet to separate ferromagnetic particles and non-magnetic components of the suspension.

In a further embodiment, the means for generating a magnetic field on an outer wall of the displacement body are arranged in the form of coils within the displacement body.

In a further embodiment, the means for generating a magnetic field on an outer wall of the displacement body are configured in the form of coils, the outer surfaces of which form the outer wall of the displacement body.

In a further embodiment, the apertures are arranged so that they can be adjusted in respect of their distance from the inner reactor wall and/or the outer wall of the displacement body.

In a further embodiment, the migrating field migrates counter to the throughflow direction.

### BRIEF DESCRIPTION OF THE DRAWINGS

Exemplary embodiments will be explained in more detail below based on the schematic drawings, wherein:

FIG. 1 shows a three-dimensional sectional view through a magnetic separation reactor,

FIG. 2 shows a sectional view through a cylindrical magnetic separation reactor in the region of an inlet,

FIG. 3 shows a sectional view through a cylindrical magnetic separation reactor in the region of the outlet,

FIG. 4 shows a displacement body with a core and magnetic coils arranged thereon, and

FIG. 5 shows a displacement body with hollow space 21 and magnetic coils arranged in the hollow space.

### DETAILED DESCRIPTION

Embodiments of the present disclosure may increase the usable penetration depth of the magnetic field in a magnetic separation reactor compared with certain conventional arrangements, thereby improving the separation rate for ferromagnetic particles and at the same time saving space.

In some embodiments, a device for separating ferromagnetic particles from a suspension, in other words a magnetic separation device, has a tubular reactor, through which a suspension flows. The reactor comprises an inlet and an outlet, as well as means for generating a magnetic field along an inner reactor wall. The tubular reactor also comprises a displacement body arranged in the interior of the reactor, wherein means for generating a magnetic field on an outer wall of the displacement body are also provided in the displacement body.

some embodiments provide a separating channel through which the suspension flows is not just penetrated from one side by a magnetic field, as is the case of certain conventional arrangements. Instead it is penetrated from two sides by two different magnetic fields, thereby enlarging the penetration depth of the magnetic fields. The hollow space 21 generally present in the displacement body is profitably used by the coil arrangement and the separation rate is increased significantly for the same reactor size. Also the volume throughput of suspension through the separation reactor can be almost doubled while the size remains the same.

Suspension here refers to a freeflowing mass of solvent, in particular water, and solids, in particular ground ore.

In one embodiment the means for generating a magnetic field, in particular coils, are controlled in such a manner that the magnetic field moves in the form of a migrating magnetic field along the inner reactor wall or the outer wall of the displacement body, in other words the non-magnetic reactor walls, in the throughflow direction of the suspension. This means that the ferromagnetic particles separated on the magnetized walls are moved along the reactor and can be separated in a specific manner in the region of the outlet. In principle the migration of the magnetic field can also take place counter to the throughflow direction, with the particles then being separated in the region of the inlet.

One embodiment includes annular apertures respectively arranged equidistant from the inner reactor wall and the outer reactor wall of the displacement body in the region of the outlet to separate the ferromagnetic particles from the non-magnetic components of the suspension. In particular when the reactor is embodied as cylindrical, the apertures are embodied as correspondingly annular. It may be expedient here for the apertures to be arranged so that they can be adjusted in relation to the magnetized surfaces, in other words the inner reactor wall or the outer wall of the displacement body, depending on the concentration of ferromagnetic particles in the suspension, so that the optimum concentration of ferromagnetic particles, transported by the migrating field in the region of the apertures, can always be separated.

There are various embodiments for the arrangement of the means for generating the magnetic field on an outer wall of the displacement body. On the one hand the hollow space 21 in the displacement body can be used to arrange the corresponding means, in particular coils, for generating a magnetic field there. It may likewise also be expedient to provide a core, in particular a cylindrical core, as the core of the displacement body and to position the corresponding means in the form of coils for generating magnetic fields thereon from the outside. In some instances such coils arranged on the core from the outside would have to be provided with a suitable material with a smooth surface.

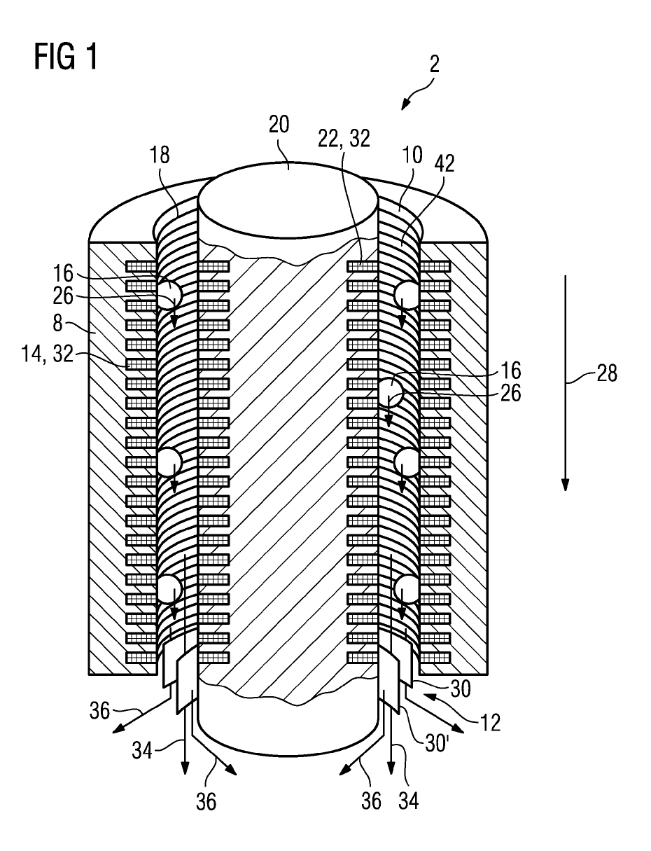

FIG. 1 shows the basic structure of a magnetic separation reactor 2 in the form of a three-dimensional sectional view. The reactor 8 is tubular, in this specific instance the term tubular also relating to a cylindrical reactor 8. Arranged on this tubular reactor 8 are means 14 for generating a magnetic field 16, said means 14 being embodied in the form of coils 32. The coils 32 are controlled in such a manner that the magnetic field 16 they generate migrates along an inner reactor wall 18 in the throughflow direction 28. In this embodiment the magnetic field 16 can be referred to as a migrating magnetic field or a migrating field, as shown by the arrows 26.

Arranged in the interior of the tubular reactor is a displacement body 20, which in this example is also arranged as a cylindrical body centrically in the tubular reactor 8.

The displacement body 20 has an outer wall 24, the centric arrangement of the displacement body 20 in the reactor 8 between the outer wall 24 of the displacement body 20 and an inner wall 18 of the reactor (inner reactor wall 18) causing an annular gap to form, which is referred to as a separating channel 42.

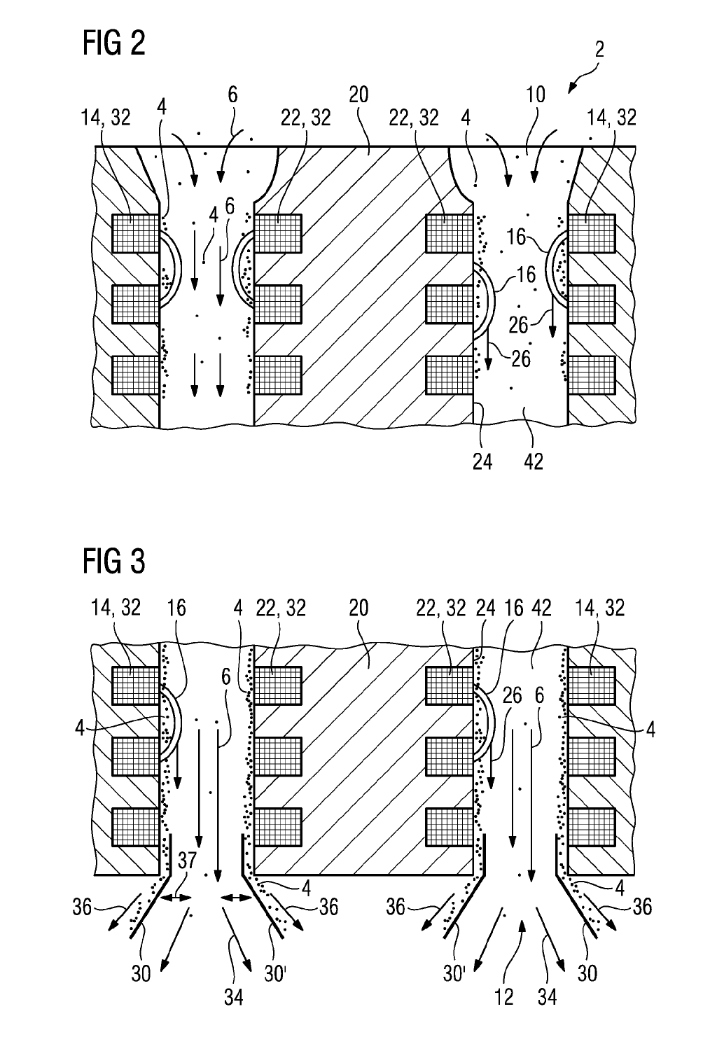

A suspension 6 (not shown here but see FIGS. 2 and 3) is passed through the separating channel 42. The suspension 6 comprises ferromagnetic particles, which are to be separated from the suspension in the separation system 2. The action of the magnetic field 16 causes the ferromagnetic particles 4 (see FIGS. 2 and 3) present in the suspension to be drawn to the inner reactor wall 18 and to be conveyed out of the reactor due to the migrating magnetic field 26 along the inner reactor wall 18 in the throughflow direction 28. A separating aperture 30 is provided for this purpose in the outlet region (outlet 12) of the reactor 8, causing the ferromagnetic particles or a concentration of ferromagnetic particles 4 to be separated from the remainder of the suspension of the so-called gangue 34.

One particular feature of the magnetic separation system 2 illustrated in FIG. 1 is that the displacement body 20 also comprises means 22 for generating a magnetic field 16, which are likewise embodied in the form of coils 32 and are arranged in the hollow space 21 in the displacement body 20. These coils 32 and the magnetic field 16 or migrating field 26 generated by them also cause ferromagnetic particles 4 to be extracted from the suspension 6, accumulating on the outer wall 24 of the displacement body 20 and being moved by the migrating field 26 in the throughflow direction 28 in the direction of a further aperture 30′. The second aperture 30′ likewise causes the particles 4, which are traveling along the outer wall 24 of the displacement body 20, to be separated from the gangue 34, which leaves the separating channel 42 between the two apertures 30 and 30′.

FIG. 2 shows a sectional drawing through a separation system 2 according to FIG. 1 in the region of an inlet 10 for the suspension 6. The suspension 6, shown by the arrows 6, which comprises ferromagnetic particles 4, shown by the dots 4, flows into the separating channel 42 in the inlet 10. Coils 32, which are arranged in the tubular reactor 8 as means 14 for generating a magnetic field 16 and are also arranged in the interior of the displacement body 20, generate a migrating magnetic field. The magnetic field 16 generated by the coils 32 migrates in the manner of a migrating field 26 along the magnetized surfaces (inner reactor wall 18 and outer wall 24 of the displacement body 20) in the throughflow direction 28 of the suspension 6 in the direction of the outlet of the reactor 8. The outlet 12 of the reactor 8 is also illustrated in the manner of a sectional drawing in FIG. 3. The separating channel 42 is divided into three subchannels by the apertures 30 and 30′, which are respectively arranged at an equidistant distance as annular apertures 30, 30′, on the one hand around the inner reactor wall 18 and on the other hand around the displacement body 20. The outward flow 36 of the ferromagnetic particles 4 runs in two of the subchannels. The gangue 34, in other words the remaining suspension, which has been separated from the ferromagnetic particles 4, runs out through the generally widest subchannel.

The distance between the apertures 30, 30′ and correspondingly magnetized walls 18 and 24 can be controlled in a variable manner as a function of the concentration of ferromagnetic particles 4 in the suspension 6 and the degree of separation of the particles 4, as shown by the arrows 37.

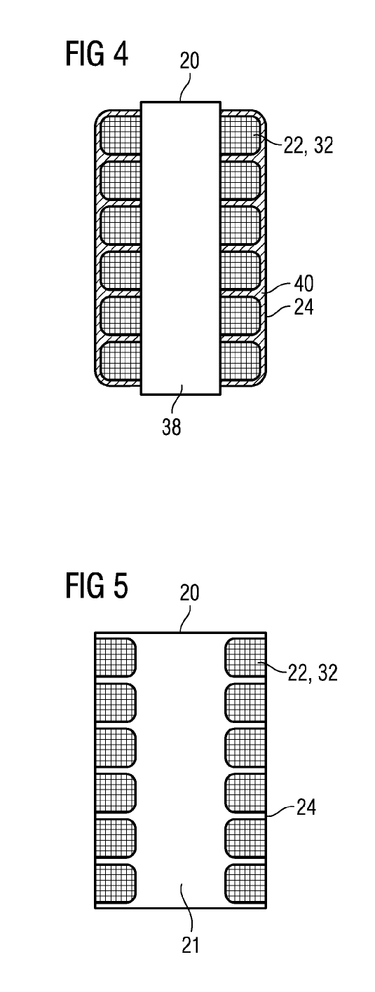

FIGS. 4 and 5 show two possible ways in which coils 32 can be arranged on the displacement body 20. In FIG. 4 the displacement body 20 has a core 38, which can be embodied in a hollow manner or as a solid material, on which coils 32 are positioned or attached as means 22 for generating a magnetic field 16. Coils 32 are generally not wound so that they are stacked one above the other to form a smooth surface, which in some instances allows a coil coating 40 to be applied to produce a smooth outer wall 24. The coil coating 40 can be embodied for example in the form of cast epoxy resin, which then forms the outer surface of the coil and the outer wall 24 of the displacement body 20.

In another embodiment of the displacement body 20 the coils 32 are introduced into the hollow space 21 in the displacement body 20, rest against its outer wall there and generate a magnetic field 16 on the outer face 24 of the displacement body 20.

As a result of these arrangements according to FIGS. 4 and 5 the existing, hitherto unused, space in the interior of the displacement body or in the interior of the reactor 8 is provided with a second set of migrating field magnetic coils. This means that the ferromagnetic particles 4 present in the suspension are influenced from two sides. This significantly increases the useful penetration depth of the magnetic field 16, so that the volume throughput of suspension 6 can be approximately doubled for the same overall size of magnetic separation system 2. The structural embodiment of the coils 32, as required by the structural space, here determines a maximum magnetic field gradient on the outer wall 24 of the displacement body 20 and on the inner reactor wall 18 respectively, which has a direct influence on the penetration depth of the magnetic field into the suspension or into the separating channel 42. These gradients can be different, so that different separating gaps 36 can also result, for which reason the apertures 30 are embodied so that they can be adjusted in respect of their distance from the wall 18′ or 24. Reactors 8 of this design allow volume flows of the suspension 6 of 10 m³/h to 500 m³/h to be achieved.

What is claimed is:

1. A device for separating ferromagnetic particles from a suspension,
a tubular reactor configured to carry the suspension, the tubular reactor comprising:
an inlet,
an outlet, and
means for generating a magnetic field along an inner reactor wall, and
a displacement body arranged in an interior of the reactor, means for generating a magnetic field on an outer wall of the displacement body.

2. The device of claim 1, the means for generating a magnetic field are configured to generate a migrating magnetic field.

3. The device of claim 2, wherein the migrating magnetic field is present on the inner reactor wall and on the outer wall of the displacement body.

4. The device of claim 2, wherein the migrating field migrates in the throughflow direction.

5. The device of claim 1, comprising arranged equidistant from the inner reactor wall and the outer wall of the displacement body at the outlet, the annular apertures being configured to separate ferromagnetic particles and non-magnetic components of the suspension.

6. The device of claim 1, wherein the means for generating a magnetic field on the outer wall of the displacement body are arranged in the form of coils within the displacement body.

7. The device of claim 1, wherein the means for generating a magnetic field on the outer wall of the displacement body are configured in the form of coils, the outer surfaces of which form the outer wall of the displacement body.

8. The device of claim 5, wherein a distance between the apertures and at least one of the inner reactor wall and outer wall of the displacement body is adjustable.

9. The device of claim 1, wherein the migrating field migrates counter to the throughflow direction.

10. A method for separating ferromagnetic particles from a suspension, comprising:
providing a tubular reactor configured to carry the suspension and comprising an inlet and an outlet, and a displacement body arranged in an interior of the tubular reactor,
generating a first magnetic field along an inner reactor wall of the tubular reactor, and
generating a second magnetic field along an outer wall of the displacement body arranged in the interior of the tubular reactor.

11. The method of claim 10, wherein generating the first and second magnetic fields form a migrating magnetic field.

12. The method of claim 11, wherein the migrating magnetic field is present on the inner reactor wall and on the outer wall of the displacement body.

13. The method of claim 11, wherein the migrating field migrates in the throughflow direction.

14. The method of claim 10, comprising using annular apertures, which are arranged equidistant from the inner reactor wall and the outer wall of the displacement body at the outlet, to separate ferromagnetic particles and non-magnetic components of the suspension.

15. The method of claim 14, comprising adjusting a distance between the apertures and at least one of the inner reactor wall and the outer wall of the displacement body.

16. The method of claim 10, comprising generating the second magnetic field on the outer wall of the displacement body using coils within the displacement body.

17. The method of claim 16, wherein the outer surfaces of the coils form the outer wall of the displacement body.

18. The method of claim 10, wherein the migrating field migrates counter to the throughflow direction.
